(19) United States
(12) Patent Application Publication
(10) Pub. No.: US 2023/0335333 A1
(43) Pub. Date: Oct. 19, 2023

(54) Coil and a Transformer That Have Improved Electromagnetic Shielding

(71) Applicant: ABB Schweiz AG, Baden (CH)

(72) Inventors: Andrea Cremasco, Eindhoven (NL); Siamak Pourkeivannour, Eindhoven (NL); Mitrofan Curti, Eindhoven (NL); Elena Lomonova, Eindhoven (NL); Daniel Rothmund, Mülligen (CH)

(73) Assignee: ABB Schweiz AG, Baden (CH)

(21) Appl. No.: 18/213,338

(22) Filed: Jun. 23, 2023

Related U.S. Application Data
(63) Continuation of application No. PCT/EP2021/087474, filed on Dec. 23, 2021.

(30) Foreign Application Priority Data
Dec. 24, 2020 (NL) N2027221

(51) Int. Cl. H01F 27/36

(52) U.S. Cl. CPC H01F 27/363

(57) ABSTRACT

A coil, comprising a magnetic core, and a conductor wound around the magnetic core; wherein a cross-section of the conductor varies along a part of the conductor that is wound around the magnetic core.

### CROSS-REFERENCE TO RELATED APPLICATIONS

The instant application claims priority to International Patent Application No. PCT/EP2021/087474, filed Dec. 23, 2021, and to Netherlands Patent Application No. N2027221, filed on Dec. 24, 2020, each of which is incorporated herein in its entirety by reference.

### FIELD OF THE DISCLOSURE

The present disclosure generally relates to electrical equipment and, more particularly, to transformers.

### BACKGROUND OF THE INVENTION

In the recent years, the need for highly efficient interfaces between the Medium-Voltage, MV, AC grid and Low-Voltage, LV, DC buses has significantly increased hand in hand with the rapidly growing amount of high-power LV DC loads and sources.

In such a scenario, the so-called Solid-State Transformers, SSTs, i.e., galvanically isolated high-power AC/DC and DC/DC converters, could replace the state-of-the art technology based on Low-Frequency Transformers, LFTs, due to several benefits such as smaller volume and weight.

The power conversion in an SST is supported by transformers operating with MV PWM waveforms in the kilohertz range. Therefore, this category of transformer is called Medium-Frequency Transformer, MFT. It features similar insulation requirements as LFT, in order to guarantee the same operational safety within the MV grid. The insulation level required are normally higher than 10.8 kV, according to IEC 62477-2. To meet these requirements, an increasing trend is observed in the isolation level considered for the design of recent MFTs.

However, due to their much higher operating frequency, MFTs are significantly more compact than LFTs for the same transferred power. Nonetheless, since the required isolation rating is independent of the specific transformer technology, the insulation thickness between the primary and the secondary side would be equal for both the MFT and the LFT. This leads to the situation that the galvanic insulation system of an MFT occupies a much larger share of the transformer's volume compared to an LFT, or, in other words, the room for additional design margins is drastically reduced for MFTs.

Therefore, the design of the insulation requires special attention to guarantee acceptable insulation distances while achieving the highest possible transformer performance, i.e., high power density and high efficiency.

The coil of a typical MFT consists of an inner secondary winding, LV, connected to the low voltage side of the converter (<1.1 kV) and an outer primary winding (HV), radially stacked to LV and connected to the side of the converter with highest voltage. The coil is installed around the magnetic circuit of the MFT, which is normally grounded for safety.

The two main technologies adopted for the conductor of MFTs are litz wire and foil conductor. The choice is a trade-off between:
Ohmic losses. They need to be limited for the efficiency requirements.
Electric field distribution. It needs to be lower than the critical limit of the insulating material.
Material cost. This may be of importance as well, considering that the cost of an MFT has a high impact on the cost of a full converter.

The high cost of Litz wire triggered several investigations towards using foil conductor. The main problems observed in using foil conductor for medium voltage MFTs are: Ohmic losses in the top and bottom edge of the conductor due to the magnetic flux crossing the conductor radially only in the upper and lower part of the coil. The electric field enhancement resulting from the electric charge accumulating on the sharp edges of the foil, towards the grounded magnetic circuit.

### BRIEF SUMMARY OF THE INVENTION

The present disclosure is directed to a solution in which both the magnetic and the electric fields are shielded in the flanges of a coil winding, which may be of importance for both the eddy current caused by radial magnetic flux, and for electric field hotspots at the edge of the conductor.

In a first aspect of the present disclosure, there is provided A coil, comprising a magnetic core and a conductor wound around the magnetic core, wherein a cross-section of the conductor varies along a part of the conductor that is wound around the magnetic core.

It has been determined that it may be beneficial to change the shape of the cross-section of the conductor along the part of the conductor that is wound around the magnetic core to thereby be able shield the magnetic and the electric fields.

A cross section indicates the representation of the intersection of the conductor by a plane along its winding direction. For example, a cylinder-shaped object is cut by a plane parallel to its base; then the resultant cross-section will be a circle.

### BRIEF DESCRIPTION OF THE SEVERAL VIEWS OF THE DRAWING(S)

FIG. 1 is a cross section for a coil in accordance with the disclosure.

FIG. 2 is a schematic of a winding in accordance with the disclosure.

FIGS. 3a, 3b, 3c, and 3d, are schematic representations of electromagnetic shield concepts in accordance with the disclosure.

FIG. 4 is an electromagnetic field shaper in accordance with the disclosure.

FIG. 5 is an electromagnetic field shaper in accordance with the disclosure.

FIG. 6 is a collection of different configurations in accordance with the disclosure.

FIG. 7 is a schematic of electromagnetic fields in accordance with the disclosure.

### DETAILED DESCRIPTION OF THE INVENTION

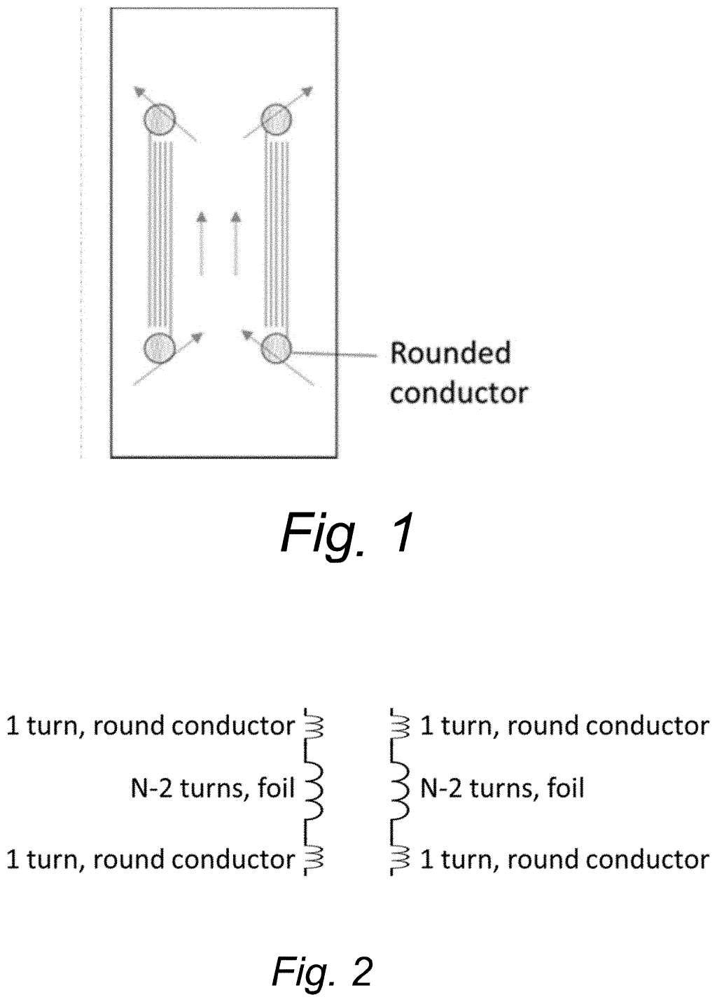

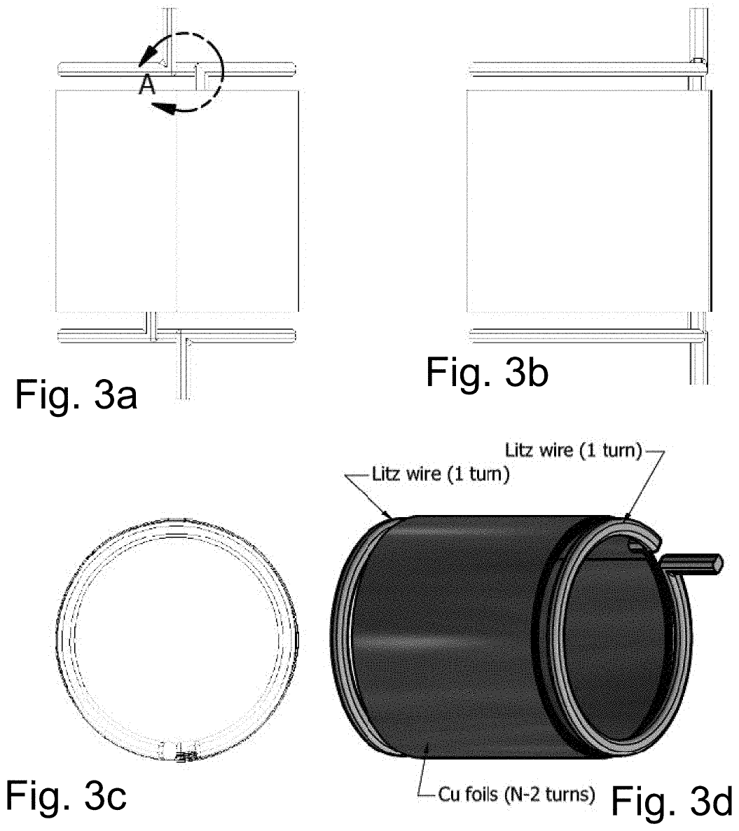

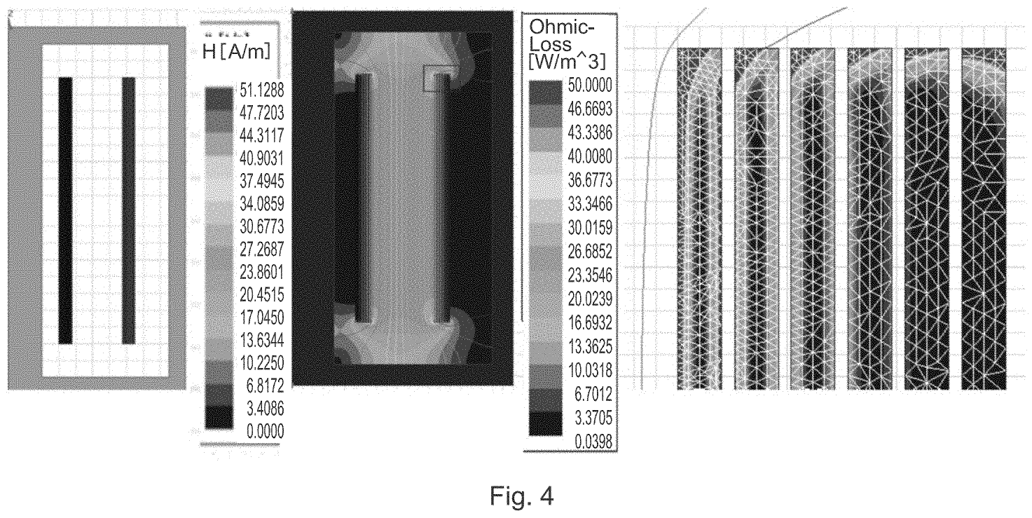

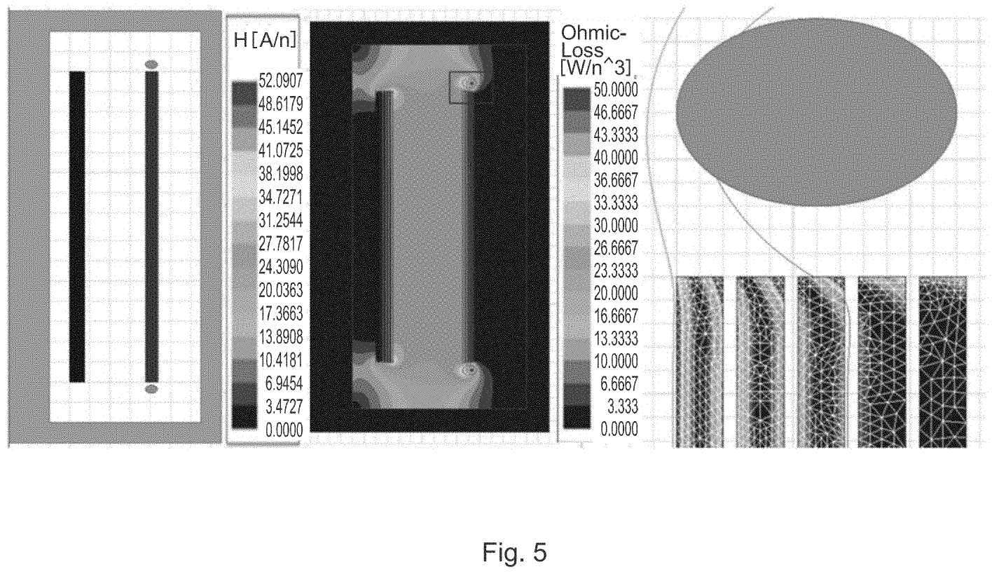

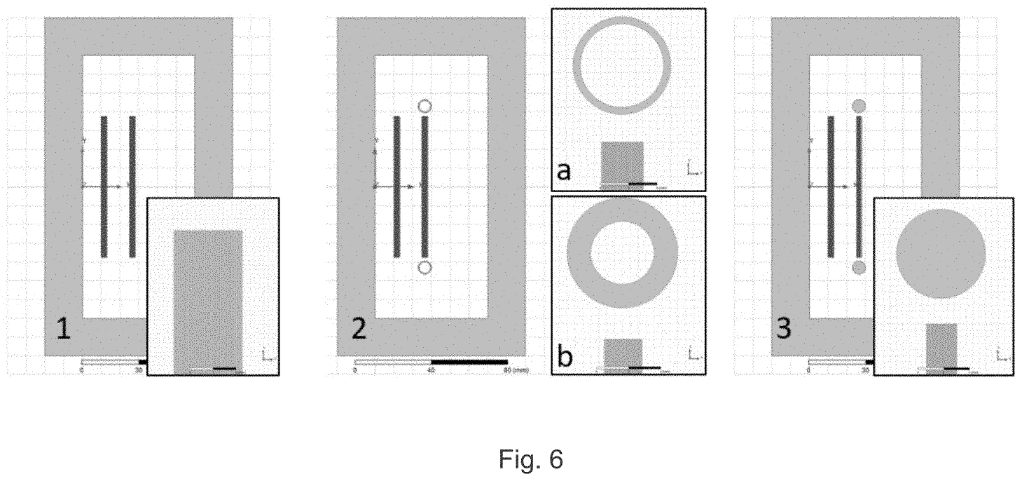

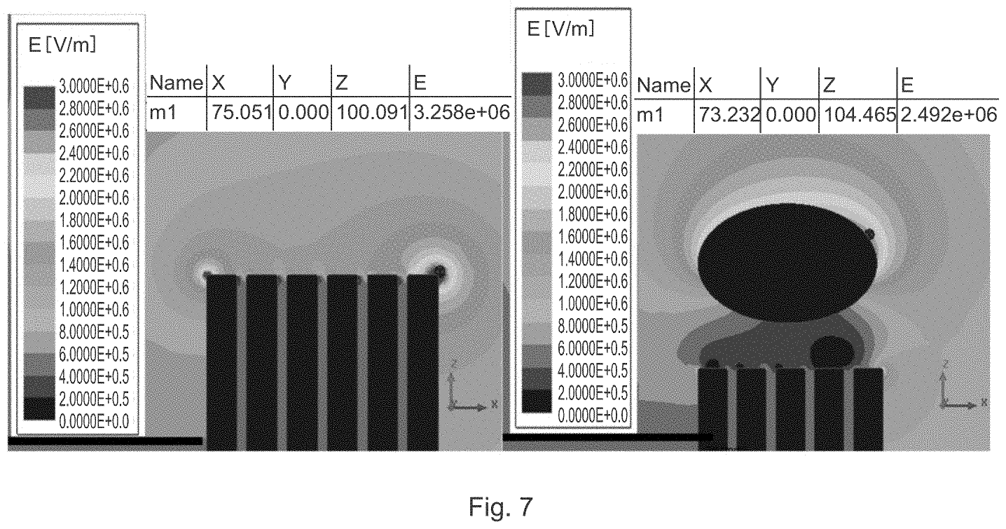

FIG. 1 shows the winding concept of the coil in accordance with the present disclosure; FIG. 2 discloses, schematically, the winding concept of the coil in accordance with the present disclosure; FIG. 3 discloses, schematically, a sketch of the Electromagnetic shield concept; FIG. 4 discloses a reference geometry without the EM field shaper, a Magnetic field intensity with flux lines and Flux lines and Ohmic loss density in correspondence to the top flange of the HV winding; FIG. 5 discloses a reference geometry with the EM field shaper on the top and the bottom of the HV winding, a Magnetic field intensity with flux lines, and Flux lines and Ohmic loss density in correspondence to the top flange of the HV winding; FIG. 6 discloses 1) a standard configuration consisting of standard foil winding, 2) a configuration consisting of foil winding and tubular shields and 3) a configuration comprising a Litz wire; FIG. 7 discloses an electric field enhancement at foil edges without the EM shaper and the electric field in correspondence to the foil conductor when shielded by the EM shaper.

A transformer winding consisting of N turns is considered. In this design, N-2 turns are manufactured with a foil conductor, following the standard procedures and allowing lower material cost compared to Litz wire. Only the first and the last turn of the winding are manufactured with a conductor having rounded cross section, electrically connected to the two ends of the winding consisting of foil conductor. The rounded conductors can be made of Litz wire or additively manufactured lattice structures, so as to prevent eddy current inside. A sketch of the concept is depicted in FIG. 2.

It is noted that the above may also be the case for more than one turn of the winding with a conductor having a rounded cross section, for example one, two, or three windings. It is further noted that, in accordance with the present disclosure, there is no need to have an integer number of turns for the winding with the conductor having the rounded cross section.

The connection between two subsequent winding sections may be obtained by wrapping, and for example soldering, both ends of the foil conductor around each Litz conductor.

These two turns shift the curvature of the magnetic field far from the foil conductor, limit the radial flux crossing it, reducing the eddy currents and the additional losses. A numerical computation confirming the effect of the EM field shaper on the magnetic field is presented when the EM shield is applied only to the HV winding. The reference case without any EM shield is shown in FIG. 4.

The case with an EM shaper is presented in FIG. 5. In the present case it was possible to reduce the Ohmic losses in the foil conductors by 20%. A more detailed analysis is performed, comparing the idea proposed with pre-existing solutions:

FIG. 6—Shield 1. This is a standard configuration consisting of standard foil winding.

FIG. 6—Shield 2. This is a configuration consisting of foil winding and tubular shields, such those used in existing solutions with litz wire (see FIG. 6). Two thicknesses of the tube are considered: a. 0.25 mm, with the tubular conductor not participating to current flow b. 0.75 mm, with the tubular conductor participating to current flow (the tubular conductor is the 1st and the last turn of the HV winding).

FIG. 6—Shield 3. The circular domain represents a litz wire.

The results obtained from the analysis of the Ohmic losses is shown 5 in the table below.

| | | | | Fail tck | Shield tck | | | |
|---|---|---|---|---|---|---|---|---|
| Shield | Is present | is a tu [symbol] | Is litz | mm | mm | HV tot loss | HV foil loss | Hv ring loss |
| 1 | | | | 0.1 | | 96 | | — |
| 2a | X | | | 0.1 | 0.25 | 168 | 109 | 59 |
| 2b | X | X | | 0.1 | 0.75 | 100 | 53 | 47 |
| 3 | X | X | X | 0.1 | 0.1 (strand) | 63 | 51 | 12 |

[symbol]

indicates data missing or illegible when filed

As expected, the tubular structure used in solution 2 is characterized 10 by high Ohmic losses (see HV ring loss).

In addition, as shown in FIG. 7, the electric field on the edges of the foil conductor is shielded by the rounded conductors, whose smooth profile does not originate electric field enhancement due to hot spot of electric charge density.

The present disclosure is, amongst other, directed to the concept that is shown in FIGS. 1 and 2. The idea is the combination of the foil conductor with a rounded conductor, for example litz or additively manufactured lattice structure, which is used both as a turn, an electric field shield as well as a magnetic field shield. In an example, the conductor is wound around the magnetic core with N turns, wherein a cross-section of at least a first of the N turns resembles a first shape and wherein the cross-section transitions into a second shape, different to the first shape, for the next of the N turns and wherein the cross-section transitions back into the first shape for at least the final turn of the N turns.

The advantage of the above provided example is that the conductor at the location at the end of the magnetic core may be provided with a different cross section compared to the conductor at the location in between the ends. This may aid in the implementation phase, by choosing cross-sections that may be helpful for, for example, at least one of the Ohmic resistance and the electro and/or magnetic field properties.

In a further example, the first shape is a rounded shape, for example a circle and the second shape are a rectangular shape, for example a rectangle.

In an example, the conductor comprises three subsequent conductor parts, wherein a first conductor part is a round conductor, wherein a second conductor part is a flat conductor and wherein a third conductor part is a round conductor.

In another example, the second conductor part comprises a foil conductor.

A foil conductor may be considered as a conductor that is capable of allowing the flow of electrical current in one or more directions. Materials made of metal are common electrical conductors. Electrical current is generated by the flow of negatively charged electrons, positively charged holes, and positive or negative ions in some cases. A foil conductor is typically characterized in that it is a flat conductor.

For example, the first conductor part and/or the third conductor part comprises a Litz wire.

A Litz wire is a type of multi-strand wire typically used in electronics to carry alternating current. The wire is designed to reduce the skin effect and proximity effect losses in conductors. It typically consists of many thin wire strands, individually insulated and twisted or woven together, following one of several carefully prescribed patterns often involving several levels.

The result of these winding patterns is to equalize the proportion of the overall length over which each strand is at the outside of the conductor. This has the effect of distributing the current equally among the wire strands, reducing the resistance. A Litz wire may be used in high Q-factor inductors for radio transmitters and receivers operating at low frequencies, induction heating equipment and switching power supplies.

In another example, the first conductor part and the second conductor part are both wound with one turn.

In a further example, a connection between any of the conductor parts is obtained by wrapping an end of the second conductor around the corresponding round conductor.

In a second aspect of the present disclosure, there is provided a transformer comprising at least one coil in accordance with any of the previous claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A coil, comprising:
a magnetic core, and a conductor wound around the magnetic core;
wherein a cross-section of the conductor varies along a part of the conductor that is wound around the magnetic core.

2. The coil in accordance with claim 1, wherein the conductor is wound around the magnetic core with N turns, wherein a cross-section of at least a first of the N turns resembles a first shape and wherein the cross-section transitions into a second shape, different from the first shape, for the next of the N turns and wherein the cross section transitions back into the first shape for at least the final turn of the N turns.

3. The coil in accordance with claim 2, wherein the first shape is a round shape, for example a circular shape, and wherein the second shape is a rectangular shape, for example a rectangle.

4. The coil in accordance with claim 1, wherein the conductor consists of three subsequent conductor parts, wherein a first conductor part is a round, rectangular or elliptic shaped conductor, wherein a second conductor part is a flat conductor and wherein a third conductor part is a round, rectangular or elliptic shaped conductor.

5. The coil in accordance with claim 4, wherein the second conductor part comprises a foil conductor.

6. The coil in accordance with claim 4, wherein the first conductor part and/or the third conductor part comprises a Litz wire.

7. The coil in accordance with claim 4, wherein the first conductor part and the second conductor part are both wound with at least one turn.

8. The coil in accordance with claim 4, wherein a connection between any of the conductor parts is obtained by wrapping an end of the second conductor part around the corresponding first or third conductor part.

9. A transformer comprising at least one coil, the at least one coil comprising:
a magnetic core, and a conductor wound around the magnetic core;
wherein a cross-section of the conductor varies along a part of the conductor that is wound around the magnetic core.

10. The transformer in accordance with claim 9, wherein the conductor is wound around the magnetic core with N turns, wherein a cross-section of at least a first of the N turns resembles a first shape and wherein the cross-section transitions into a second shape, different from the first shape, for the next of the N turns and wherein the cross section transitions back into the first shape for at least the final turn of the N turns.

11. The transformer in accordance with claim 10, wherein the first shape is a round shape, for example a circular shape, and wherein the second shape is a rectangular shape, for example a rectangle.

12. The transformer coil in accordance with claim 1, wherein the conductor consists of three subsequent conductor parts, wherein a first conductor part is a round, rectangular or elliptic shaped conductor, wherein a second conductor part is a flat conductor and wherein a third conductor part is a round, rectangular or elliptic shaped conductor.

13. The transformer in accordance with claim 12, wherein the second conductor part comprises a foil conductor.

14. The transformer in accordance with claim 12, wherein the first conductor part and/or the third conductor part comprises a Litz wire.

15. The transformer in accordance with claim 12, wherein the first conductor part and the second conductor part are both wound with at least one turn.

16. The transformer in accordance with claim 12, wherein a connection between any of the conductor parts is obtained by wrapping an end of the second conductor part around the corresponding first or third conductor part.
